(19) United States
(12) Patent Application Publication
(10) Pub. No.: US 2008/0136247 A1
(43) Pub. Date: Jun. 12, 2008

(54) Shield assembly for dressing tires

(75) Inventor: David J. Janty, Bolton, CT (US)

Correspondence Address: IRA S. DORMAN, 330 ROBERTS STREET, SUITE 200, EAST HARTFORD, CT, 06108, US

(73) Assignee: Birch Mountain Design, LLC.

(21) Appl. No.: 11/637,404

(22) Filed: Dec. 12, 2006

(51) Int. Cl. B60B 7/00

(52) U.S. Cl. 301/37.104

(57) ABSTRACT

A shield assembly for dressing a tire mounted on a wheel rim includes a disc member and at least one holding device, the disc member being dimensioned to overlie, and thereby protect, at least the rim of the wheel during application of a tire dressing material. The holding device is of adjustable length, and may include other variable features so as to enable use with virtually any common style and size of motor vehicle wheel.

### BACKGROUND OF THE INVENTION

It is common practice to apply a liquid dressing material, often by spraying, to the sidewalls of motor vehicle tires for enhancement of appearance. Overspray detracts significantly from the effect, however, due largely to the accumulation of dust and dirt in the dressing material that has been deposited upon wheel rim and/or hubcap surfaces.

United States patents to Hudgins et al., U.S. Pat. No. 2,627,839, to Fair, U.S. Pat. No. 4,784,440, and to Koller, U.S. Pat. No. 4,955,670 are all directed to masks or shields, having attachment means, for protecting wheel surfaces of a vehicle during application of a tire dressing material. The need remains however for an attachable shield assembly and method for effectively protecting vehicle wheel surfaces against tire dressing material overspray, which shield assembly has wide applicability and versatility, is incomplex and durable, and is quick, facile and convenient to employ.

### SUMMARY OF THE INVENTION

Accordingly, it is the broad objects of the present invention to provide a novel shield assembly for protecting vehicle wheel surfaces against contact by tire dressing material during the spray application thereof, and to provide a novel method of tire dressing utilizing the same.

More specific objects of the invention are to provide such a shield assembly which has utility for protecting surfaces of wheels of various styles and having a wide range of dimensions.

Additional objects are to provide a shield assembly having the foregoing features and advantages, which is of incomplex and durable construction, is highly effective for its intended purposes, and is quick, facile and convenient to employ.

It has now been found that the foregoing and related objects of the invention are attained by the provision of a shield assembly, and a method in which it is used, that includes a disc member comprised of a disc component having structure defining a plurality of openings adjacent its periphery, and at least one, but preferably a plurality and most desirably a pair, of holding devices operatively associated therewith. Each holding device comprises a shaft portion, a handle portion at one end of the shaft portion and a hook portion at the opposite end thereof, an engagement piece mounted for movement along the length of the shaft portion, and compressible biasing means for urging, from a compressed state, the engagement piece toward the hook portion. The shaft portion of the holding device is dimensioned and configured for passage through, and rotation within, an opening formed in the disc component, as defined by the openings-defining structure, and the engagement piece has at least one transverse dimension that is effective for operatively engaging the disc member. When the holding device is assembled with the disc member with the shaft portion passing through the opening in the disc component, with the handle portion and engagement piece on the same side of the disc member, and with the transverse dimension of the engagement piece effectively aligned, the engagement piece will engage the disc member (generally, structure defining the formed opening) so as to cause the biasing means to urge, from a compressed state, the hook portion of the holding device toward the disc member. That will in turn cause a clamping force to be exerted by the hook portion and the disc member upon portions of a tire-mounting wheel positioned therebetween, and thereby secure the disc member in place proximate the mounted tire.

In preferred embodiments of the shield assembly the shaft portion of the holding device will be of variable effective length, as may be achieved by employing a plurality of parts that are constructed for being affixed to one another in a multiplicity of longitudinally displaced relative positions. More specifically, the shaft portion will desirably consist of two parts, one being a hollow tubular part, sleeve or housing, with which the other part (e.g., an extension rod) is telescopically interengaged, and the biasing means may comprise a coil spring received in a bore or passage in the tubular part. The engagement piece will advantageously comprise a generally annular element that surrounds, and is slidably mounted upon, the tubular part of the shaft portion, and that has tang elements that extend through longitudinal slots formed in the tubular part so as to engage a coil of the internal spring.

Alternatively, the shaft portion of the holding device may have an externally threaded section along at least part of its length, and the handle portion may comprise an internally threaded handle member, or subassembly, threadably engaged with the threaded section of the shaft portion. The effective length of the shaft portion can thus be adjusted by varying the longitudinal position of the handle member on the threaded section.

The handle and hook portions of the holding device will most desirably be removably attached to the shaft portion, so as to enable substitution of components of different styles and/or dimensions. The disc component of the disc member will preferably be fabricated from a clear, transparent plastic material (e.g., of a polyolefin or a polycarbonate resin), and it will usually be provided with a peripheral ring of gasket material (e.g., of a foamed synthetic rubber), on the inner side thereof; the disc component will advantageously have at least a central bulged area that is of concavo-convex form, the concavity being on the inner side thereof. The openings-defining structure on the disc component will usually include components that extend generally radially, and will normally comprise lines of weakness formed into the material from which the disc component is fabricated, the lines of weakness facilitating removal of knockouts for forming the actual openings.

### BRIEF DESCRIPTION OF THE DRAWINGS

FIG. 1 is a fragmentary perspective view showing the spray application of a dressing material to a tire on an automobile, the adjacent mounting rim surfaces being protected against overspay deposits by a shield assembly embodying the present invention;

FIG. 2 is an elevational view of the front (outer side) of a disc member suitable for use in a shield assembly embodying the invention, much of the peripheral edge portion of the disc component being broken away to expose the annular gasket that is affixed to the back (inner) surface thereof;

FIG. 3 is an edge view of the disc member of FIG. 2;

FIG. 4 is a perspective view depicting one form of holding device that is suitable for use in the shield assembly of the invention;

FIG. 4a depicts a laterally elongated hook piece of which the holding device of FIG. 4 may be comprised;

FIG. 5 is an exploded view showing the elements of which a second form of holding device is comprised.

FIGS. 5a, 5b and 5c depict three different styles of handles that are suitable for use in the holding device of FIG. 5;

FIG. 5d is a plan view, drawn to an enlarged scale, showing the engagement piece employed in the holding device of FIG. 5;

FIG. 6 is an elevational view of vehicle wheel over which is positioned concentrically the protective disc member of an assembly embodying the invention, prior to being secured in place;

FIG. 7 is an elevational view showing a holding device in the course of insertion through the protective disc member and vehicle wheel, the disc member and wheel being depicted fragmentarily and with portions broken away;

FIG. 8 is a perspective view showing a shield assembly embodying the invention secured in operable position upon a diagrammatically illustrated wheel rim;

FIG. 9 is a perspective view of a shield assembly embodying the invention being applied to a wheel that includes a hubcap, components being shown, for clarity of illustration, in an exploded relationship to one another;

FIG. 10 is a diagrammatic representation depicting various forms of openings-defining structures in a protective disc component, suitable for use in the shield assembly of the invention; and

FIG. 11 shows a modified form of shield assembly embodying invention, which includes a drape for providing an extended area for overall protection of the wheel.

### DETAILED DESCRIPTION OF THE PREFERRED AND ILLUSTRATED EMBODIMENTS

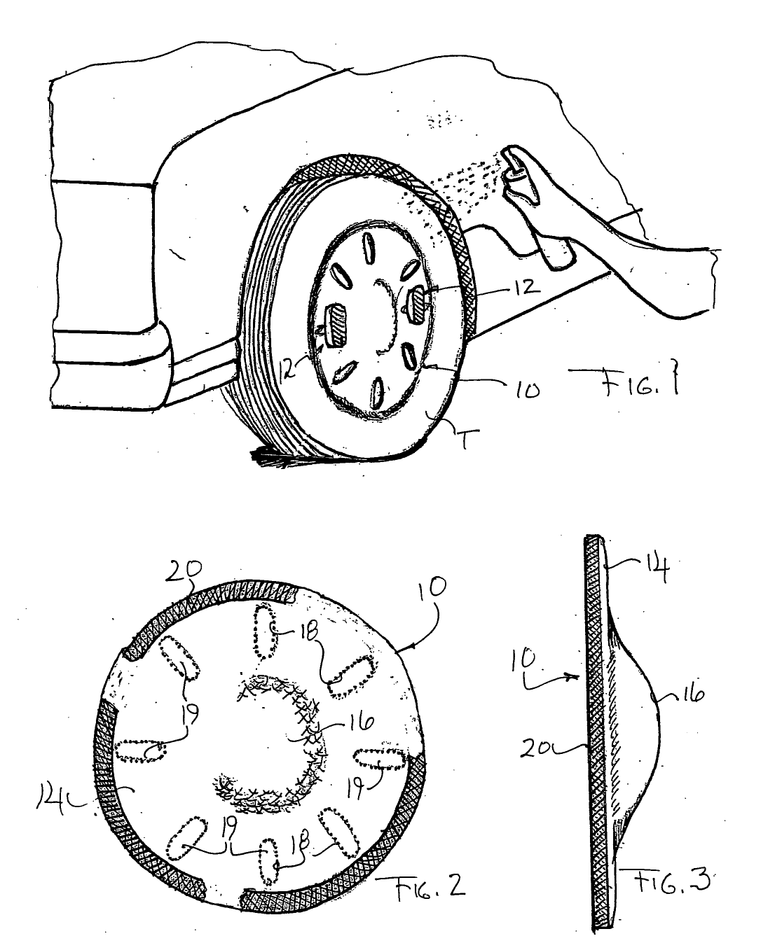

Turning initially to FIG. 1 of the drawings, therein illustrated is a shield assembly embodying the present invention, operatively mounted upon a wheel of an automobile. The assembly consists essentially of a disc member, generally designated by the numeral 10, and a pair of substantially identical holding devices, each being generally designated by the numeral 12. The assembly is positioned against and secured to the wheel of the vehicle in such manner that the underlying tire-mounting rim (not visible) is protected while leaving the sidewall of the tire T exposed for contact by the spray of liquid dressing material being directed theretoward.

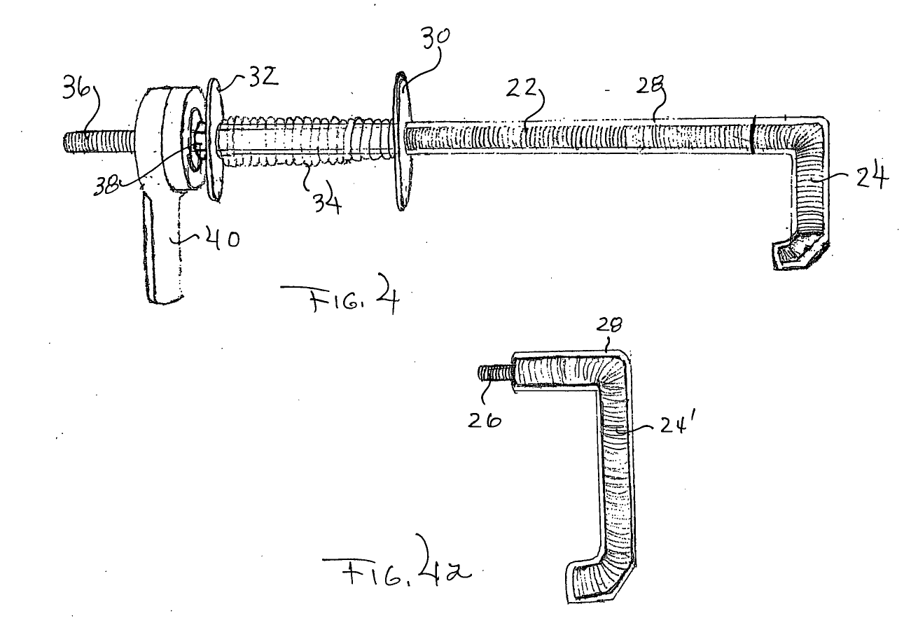

With additional reference to FIGS. 2 and 3, the disc member 10 is seen to consist of a disc component 14 having a central, outwardly bulged area 16, surrounded by eight oblong opening-defining patterns 18 of perforations, each perforation pattern 18 defining a knockout element 19. A foam rubber gasket ring 20 is attached (e.g., bonded) against the circumferential margin of the disc component 14, on the inside or back surface (i.e., the concave side of the bulge area 16), which engages, in a sealing manner, the edge of the wheel rim when the assembly is properly mounted, as in FIG. 1.

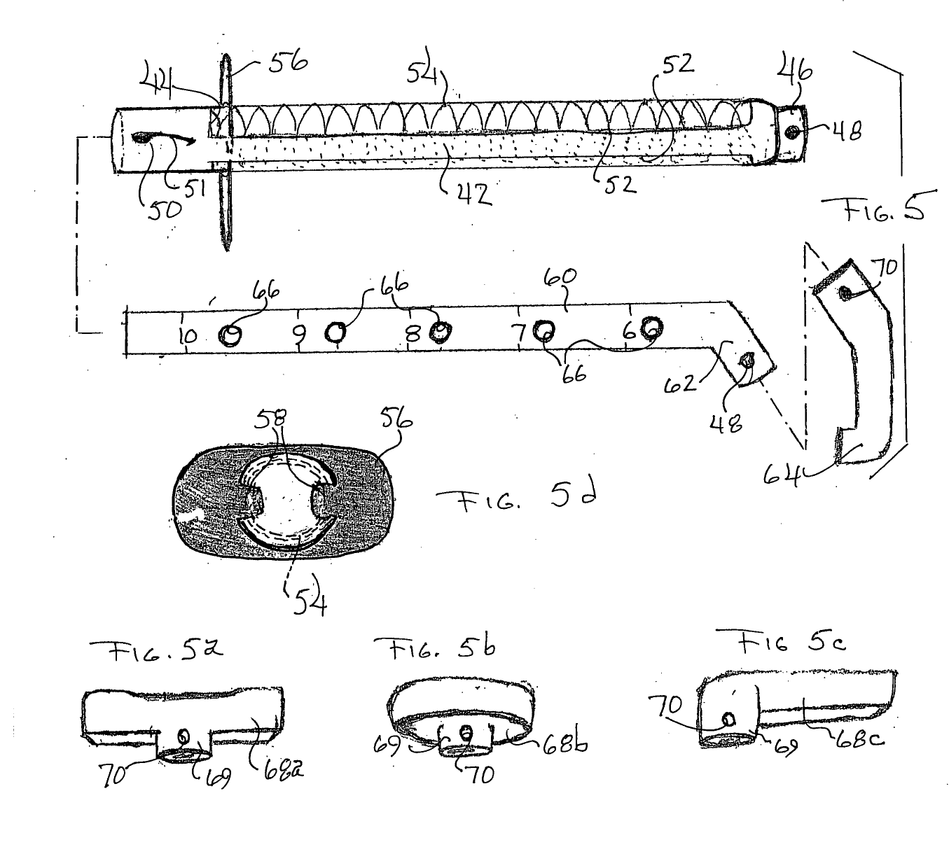

Turning now to FIG. 4, a mechanism providing one form of holding device 12, suitable for use in the assembly of the invention, is depicted. It comprises of a rectilinear piece 22 of threaded rod stock and a hook piece 24, which is also fabricated from threaded rod stock, disengageably attached to one end of the piece 22. As will be appreciated from FIG. 4a, a hook piece 24′, having an extended reach (longer lateral dimension), can be substituted for the piece 24 simply by unscrewing the piece 24 from the end of the rectilinear piece 22 and replacing it with the piece 24′; a threaded stub 26 (engageable in a matingly threaded axial bore, not seen, in the end of the piece 22) is provided for that purpose. The hook pieces 24, 24′, and most of the length of the rectilinear piece 22, are coated with a layer 28 of a plastic material, essentially for surface smoothness and for protecting parts of the disc member and the wheel rim from damage due to contact by the threads of the rod stock, during insertion.

The engagement piece 30 is slidably mounted upon the rectilinear piece 22, and is biased toward the hook piece 24 by a coil spring 34, which extends between, and bears at its opposite ends against, the engagement piece 30 and a retaining washer 32. The retaining washer 32 is held in position on one side (the side distal to the hook piece 24) by a nut 38, which is threadably engaged on a bare section 36 of the rectilinear piece 22 and is, in turn, engaged in the handle 40 relative to the piece 22 against rotation relative thereto. As will be appreciated, turning of the handle 40 relative to the piece 22 will adjust the position of the nut 38 and thereby vary of the effective length of the holding device (i.e., the distance between the handle 40 and the hook piece 24). The position of the handle 40 on the bare section 36 of the rectilinear piece is secured by a second nut (not seen), which is tightened against the outer surface of the handle 40 and cooperates with the nut 38 to lock the handle against rotation relative to the piece 22 and to thereby permit turning of the device using the handle.

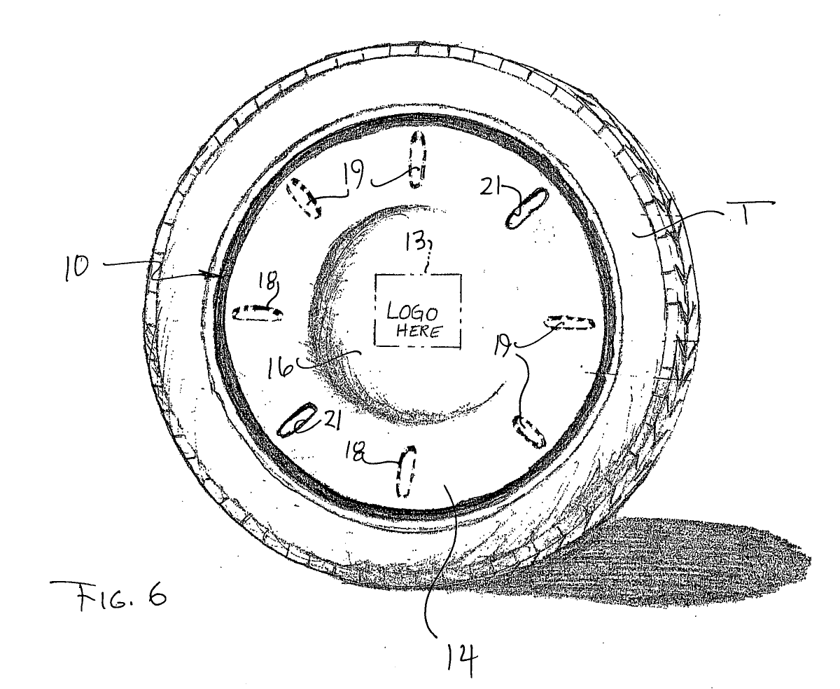

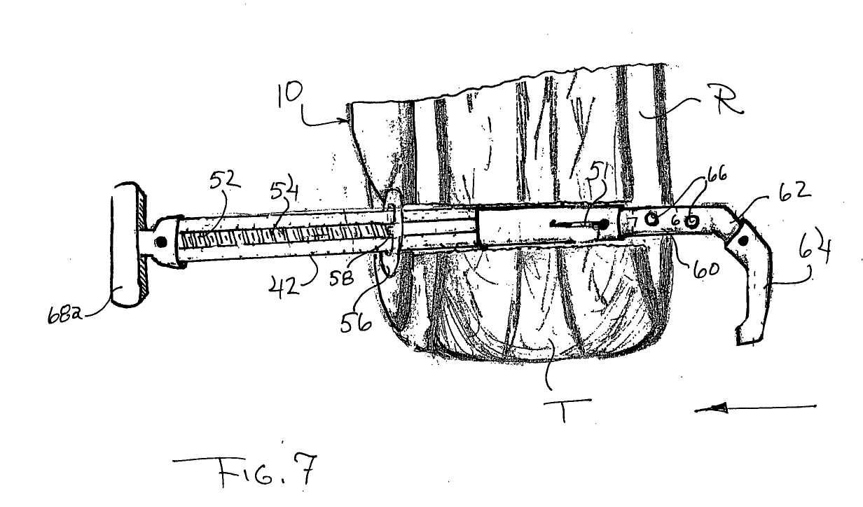

A second form of mechanism embodying the holding device 12 is depicted in FIG. 5 of the drawings, and comprises a hollow, generally tubular part or sleeve piece 42, and an extension rod 60 telescopically interengaged therewith.

The assembly also includes an engagement element, in the form of an oblong washer 56 (most fully illustrated in FIG. 5d), a coil spring 54, and a hook piece 64. The coil spring 54 is received in the bore 44 of the tubular piece 42, and bears at one end against a short post or plug 46, which is affixed within the bore 44 at the end of the tubular part. The post 46 carries a trapped, inwardly displaceable spring-loaded detent element 48, which may take the form of a ball that protrudes slightly above the surface of the post 46 and that serves, in conventional manner, for disengagable attachment of a selected one of the three handles 68a, 68b or 68c illustrated, respectively, in FIGS. 5a, 5b, and 5c. It will be noted that each handle 68 has a hub portion 69 in which is formed an aperture 70 for receiving and engaging the spherical detent element 48.

The extension piece 60 is essentially a rectilinear length of rod stock, but it has a short, angularly offset portion 62 at one end. As indicated in FIG. 5, the piece 60 is inserted into the bore 44 of the tubular piece 42 by introducing the straight end portion of the former into the open end of the latter. A series of recesses 66 are formed at one-inch intervals along the length of the extension piece 60, each being marked with an associated number “6,” “7,” “8,” “9,” and “10.” The numbers are indicative of the depth at which rim structure to be engaged, or the rear surface of a mounted tire, is located, and thereby allow prepositioning of the extension piece 60 within the sleeve piece 42 so as to most conveniently enable utilization of the holding device for securing the shield member on the wheel. A hemispherical detent element 50 is disposed at the end of a mounting leaf spring 51, which is attached to the sleeve piece 42 adjacent the entry end of the bore 44. An aperture (not visible) formed through the sleeve piece 42 permits the detent element 50 to extend into engagement with each of the recesses 66 so as to readily enable the extension piece 60 to be affixed in a selected position of extension relative to the sleeve piece 42. The hook piece 64 is disengageably attached to the offset portion 62 of the extension piece 60, again utilizing a detent/aperture arrangement 48, 70, as previously described.

The oblong engagement piece 56 is slidably mounted upon the tubular piece 42, and has a pair of diametrical ears or tangs 58 that extend into the bore 44, through the longitudinal slots 52, and engage between two adjacent coils of the spring 54. The spring 54 thereby catches or captures the engagement piece 56 and applies a force that biases it away from the closed, handle-receiving end of the tubular piece 42.

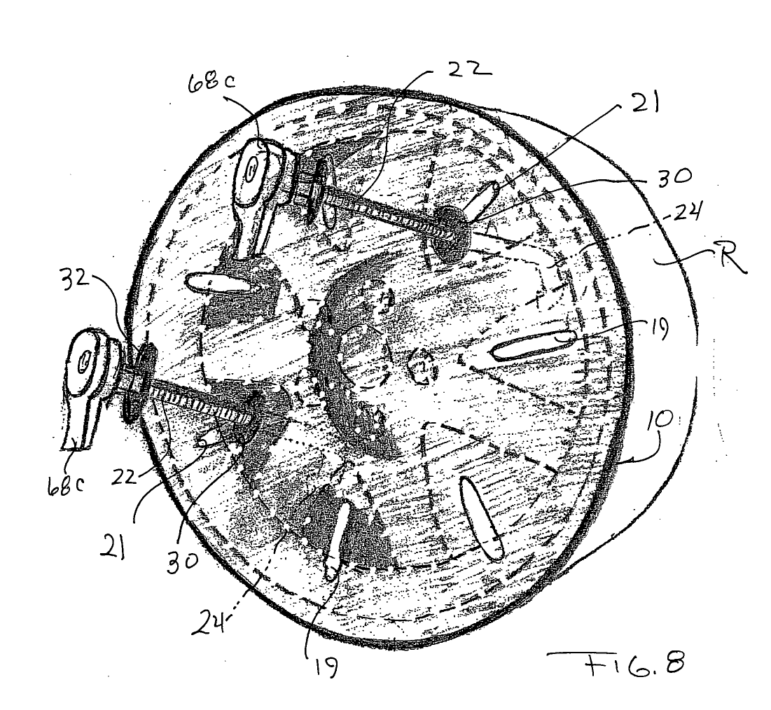

FIG. 6 depicts the disc member 10 in concentric position against the rim (not seen) of a wheel on which a tire T is mounted, prior to insertion of any holding device 12. As can be seen, two knockouts 19 have been removed from the disc component 14, at generally diametrical positions, so as to define actual openings or holes 21. The Figure also suggests that a logo might desirably be provided in a central location, on the area of the bulge 16, as indicated by the dotted-line rectangle 13 and the words “LOGO HERE.”

Utilization of the holding device depicted in FIGS. 5-5d is illustrated in FIG. 7. Although not visible, it will be appreciated that two holes 21 would have been formed in the disc component 14 of the disc member 10, as by removing knockouts 19 from two generally diametrical positions thereon, each hole 21 serving of course to receive one of the holding devices. After positioning the disc member 10 against the rim of the wheel (as depicted in FIG. 6), a holding device would be inserted through each hole 21 and manipulated so as to pass the hook piece 64 through the wheel and thus locate it as shown in FIG. 7. It will be appreciated that, in doing so, the engagement piece 56 will be brought into contact with the structure surrounding the hole in the disc component, causing the coil spring 54 to compress as the holding device is inserted more deeply into the rim. The release of force upon the handle 68a will of course enable the spring 54 to urge the assembled sleeve piece 42, extension rod 60, and hook piece 64 outwardly (as indicated by the arrow in FIG. 7), ultimately causing the hook piece 64 to engage the inside of the tire T and thereby to secure the disc member in place (under the force generated by spring 54) in a protective relationship against the outer surface of the rim R on which the tire is mounted.

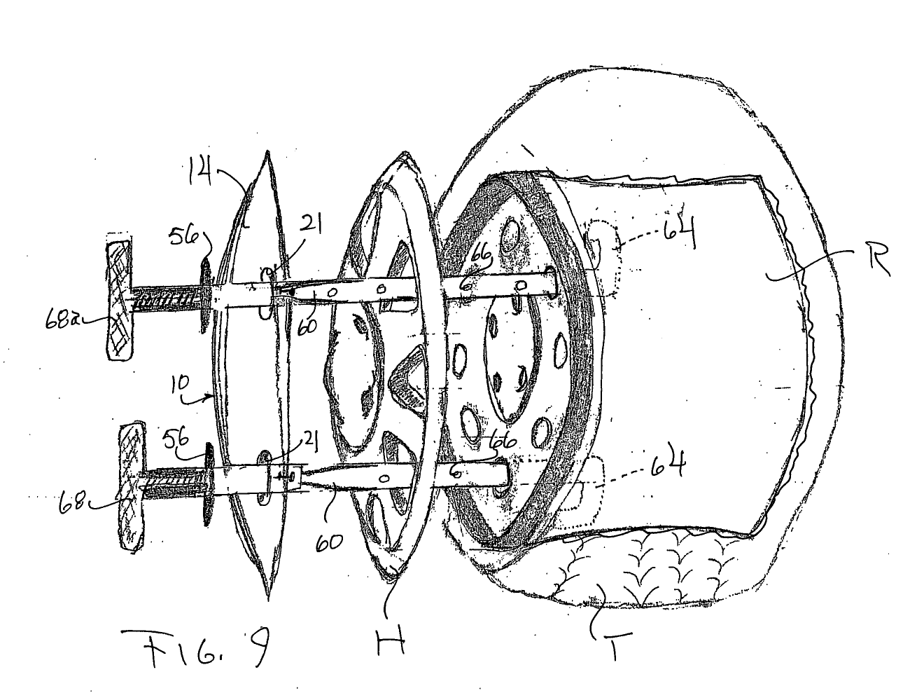

FIG. 8 illustrates the use of a pair of holding devices, constructed as depicted in FIG. 4, for securing a disc member 10 against a tire-mounting rim R (no tire is shown), utilizing the spokes structure of the rim, rather than a mounted tire, for internal engagement of the holding devices. Because the holding devices need not reach laterally behind the tire the shorter hook piece 24 (rather than the hook piece portion 24′ shown in FIG. 4a) can be employed.

FIG. 9 depicts a further application for the assembly of the invention wherein, in addition to a rim and a tire the wheel with which the assembly is employed includes a hubcap H. As will be appreciated, the disc component 14 will be of a diameter sufficient to overlie the hubcap H, and here again the holding devices engage the rim R rather than the tire T.

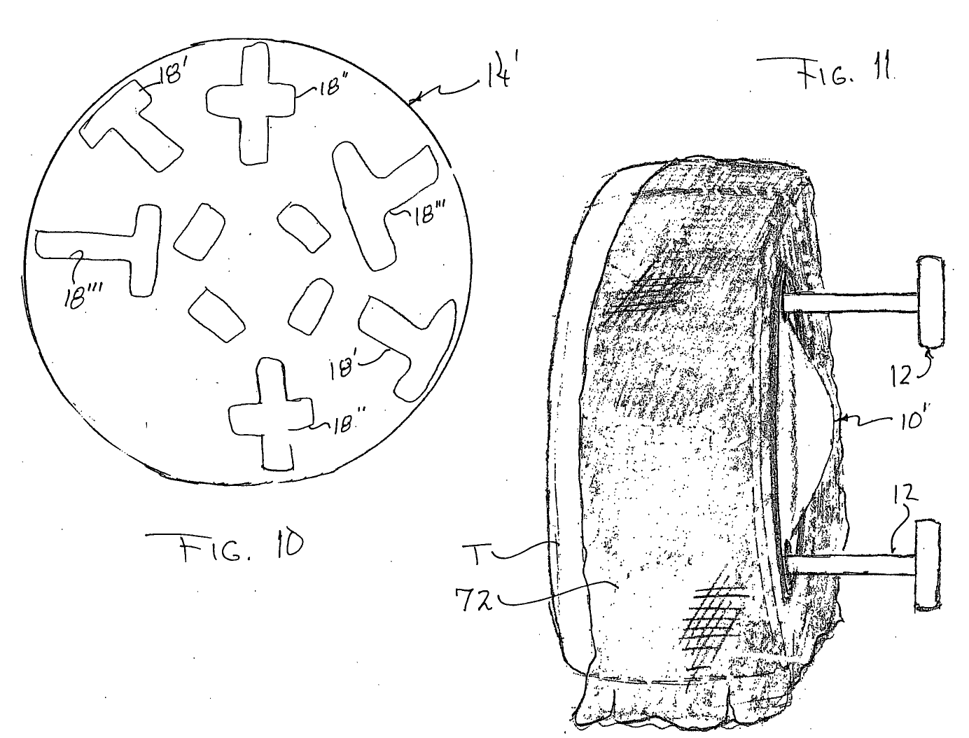

FIG. 10 is a diagrammatical representation of a disc component 14′, in which three different styles of opening-defining formations 18′, 18″ and 18′″ are depicted. It will be appreciated that this Figure is merely illustrative of variations that might be employed. In any event, it will be noted that, in addition to having a radially extending component each formation depicted in FIG. 10 also includes a transverse component, thus affording added latitude in the ability to manipulate the holding device for achieving optimal positioning.

Turning finally to FIG. 11 of the drawings, therein illustrated is an embodiment of the invention wherein the shield assembly has been augmented with a web or drape 72 of material (e.g., a fabric or a plastic film or sheet), dimensioned to cover at least a substantial part of the mounted tire. For that purpose, it will be appreciated that the drape 72 is formed with a circular opening (not visible), with the surrounding margin secured to the periphery of the disc member 10′ so as to provide a continuous protective unit. Straps (not shown) having fastening means thereon (e.g., hook and loop-type fabric strips) may be employed to better secure the drape 72 in place, if so desired. Such a shield assembly might be used for example during repair or painting of a vehicle, rather than for protection against wheel dressing overspray.

Any suitable materials can be employed for fabricating of the several components and elements of which the instant assembly is comprised. It will generally be advantageous, however, to employ a synthetic resinous material (plastic) in producing the disc component of the disc member, which will preferably be transparent so as to enable a clear view of the wheel rim and the back of the tire to thereby facilitate manipulation of the holding device for most convenient and rapid engagement and application of the disc member. The disc member may be of any suitable diameter, but will typically be provided in diameters ranging from 15 inches to 22 inches, and perhaps most commonly in diameters of 18, 19, and 20 inches for use on wheels of present-day motor vehicles.

The openings-defining structures may take any suitable form, and may comprise, for example, patterns of perforations, die-cut or molded partial incisions, or other means providing lines of relative weakness circumscribing conveniently removable knockouts. The shape, position, and number of knockouts provided on a given disc component may vary widely, and may be employed in numerous combinations; typically however eight potential openings will be defined, as illustrated. Albeit much less desirable, the openings-defining structure may take the form or mere markings or indicia (rather than lines of weakening) showing where holes would desirably be cut by the consumer.

The holding device, intended for automative use, will usually have a maximum extended length of about 12 inches and a minimum, fully collapsed length (when for example the parts are telescopically interengaged) of about 7 inches. To provide a desirable range of utility, the holding device will typically be constructed to enable it to reach to a depth of about 6 to 10 inches, as reflected in FIG. 5 of the drawings, and the hook portion will typically have a lateral extent of 1 to 4 inches. A tubular piece, such as 42 in FIG. 5, and an assembled extension rod 60, will typically have diameters of about ⅜ inch and 3/16 inch, respectively. Needless to say, proportionately larger dimensions may be appropriate when the device is to be employed for trucks or other oversize vehicles. While two holding devices, at diametric positions, will usually be employed to secure the disc member in place, that will not necessarily be the case. In some instances, for example, the structure of the wheel will make non-diametric positioning more convenient of feasible (as seen in FIG. 9) and, as indicated above, only a single holding device (or indeed, more than two holding devices) may be utilized; the disc member would of course be constructed or adapted accordingly.

As suggested above, virtually any form of handle can be utilized in the holding device, and the handles can be constructed for interchangeability, as illustrated. It may nevertheless be found that a handle formed with a laterally-extending portion (e.g., handles 68a and 68c, illustrated in FIGS. 5a and 5c respectively) affords the best manipulation capability. Indeed, it will often be preferred to so construct the holding device that, when properly assembled, a laterally extending portion of the handle (e.g., of handle 68c) will be aligned to lie in the plane in which the laterally extending hook piece 24, 24′ or 64) is disposed so as to inherently indicate the orientation of the latter without need for actual viewing of its position.

Virtually any form of engagement piece can be utilized, provided it has a portion that is, or elements that are, dimensioned and configured to operatively bear upon the disc component. Needless to say, the engagement piece must function to provide a stop against which the biasing means of the holding device can act (directly or indirectly) to generate the force necessary for securing the disc assembly in position. And finally, although a coil spring will, in most instances, be utilized as the biasing means, other functionally equivalent means (e.g., compressible elements of elastomeric materials) may be substituted in appropriate circumstances.

Thus, it can be seen that the present invention provides a novel shield assembly for protecting vehicle wheel surfaces against contact by tire dressing material during the spray application thereof, and a novel method for dressing a tire. The shield assembly has utility for protecting surfaces of wheels of various styles and having a wide range of dimensions, and it is of incomplex and durable construction, is highly effective for its intended purposes, and is quick, facile and convenient to employ.

Having thus described the invention, what is claimed is:

1. An attachable shield assembly for dressing a tire mounted on a wheel, comprised of a disc member including a disc component having openings-defining structure defining a plurality of actual or potential openings adjacent its periphery; and at least one holding device, said holding device comprising a shaft portion having opposite ends, a handle portion at one of said opposite ends of said shaft portion, a hook portion at the other of said opposite ends of said shaft portion, an engagement piece mounted for movement along the length of said shaft portion, and compressible biasing means for urging, from a compressed state thereof, said engagement piece toward said hook portion, said shaft portion of said holding device being dimensioned and configured for passage through, and for rotation within, an opening formed in said disc component as defined by said openings-defining structure, and said engagement piece having at least one transverse dimension that is effectively larger than a transverse dimension of a said formed opening; whereby, when said holding device is assembled with said disc member, with said shaft portion passing through a said formed opening in said disc component, with said handle portion and engagement piece on the same side of said disc member, and with said engagement piece aligned to operatively engage said disc member, said biasing means may urge, from a compressed state thereof, said hook portion of said holding device toward said disc member, in turn causing a clamping force to be exerted by said hook portion and said disc member upon portions of a tire-mounting wheel positioned therebetween, and thereby serving to secure said disc member in place proximate the mounted tire.

2. The shield assembly of claim 1 wherein said shaft portion of said holding device is of variable effective length.

3. The shield assembly of claim 2 wherein shaft portion of said holding device is comprised of a plurality of parts, said parts being constructed for being affixed to one another in a multiplicity of longitudinally displaced relative positions so as to enable variation of the effective length of said shaft portion.

4. The shield assembly of claim 3 wherein said shaft portion consists of two of said parts, telescopically interengaged with one another.

5. The shield assembly of claim 1 wherein said shaft portion comprises a hollow tubular part, and wherein said biasing means comprises a coil spring received within said tubular part.

6. The shield assembly of claim 5 wherein said tubular part has a plurality of longitudinal slots extending along the length thereof for communication with said biasing means received therewithin, wherein said engagement piece comprises a generally annular element and a plurality of tang elements, said annular element surrounding, and slidably engaging, said tubular part and said tang elements extending through said longitudinal slots into operative engagement with at least one coil of said spring.

7. The shield assembly of claim 1 wherein at least one of said handle portion and said hook portion of said holding device is removably attached to said shaft portion thereof.

8. The shield assembly of claim 1 wherein said disc component of said disc member is fabricated from a transparent plastic material.

9. The shield assembly of claim 1 wherein said disc member includes a peripheral ring of gasket material on an inner surface of said disc component.

10. The shield assembly of claim 9 wherein said disc component has at least a central area that is outwardly bulged.

11. The shield assembly of claim 1 wherein said each of said plurality of actual or potential openings defined by said openings-defining structure comprises an elongate component that extends generally radially on said disc component.

12. The shield assembly of claim 11 wherein said openings-defining structure comprises lines of weakness formed in the material from which said disc component is fabricated, said lines of weakness facilitating removal of areas of said material to form actual openings through said disc component.

13. The shield assembly of claim 1 wherein said shaft portion has an externally threaded section along at least part of its length, and wherein said handle portion comprises an internally threaded handle member threadably engaged with said threaded section of said shaft portion, whereby the effective length of said shaft portion can be adjusted by varying the longitudinal position of said handle member on said threaded section.

14. The shield assembly of claim 1 comprising a pair of said holding devices.

15. A method for dressing a tire mounted on a wheel rim, comprising the steps:
providing a disc member including a disc component having openings-defining structure defining a plurality of actual or potential openings adjacent its periphery;
providing at least one holding device, said holding device comprising a shaft portion having opposite ends, a handle portion at one of said opposite ends of said shaft portion, a hook portion at the other of said opposite ends of said shaft portion, an engagement piece mounted for movement along the length of said shaft portion, and compressible biasing means for urging, from a compressed state, said engagement piece toward said hook portion, said shaft portion of said holding device being dimensioned and configured for passage through, and for rotation within, an opening formed in said disc component as defined by said openings-defining structure, and said engagement piece having at least one transverse dimension that is effectively larger than a transverse dimension of a said formed opening;
assembling said at least one holding device with said disc member and said wheel rim by placing said disc member in a concentric position upon said wheel rim, by passing said shaft portion of said holding device through an actual one of said openings in said disc component with said handle portion and engagement piece on the same side of said disc member, and with said at least one transverse dimension of said engagement piece aligned to operatively engage said disc member so as to cause said biasing means to urge, from a compressed state thereof, said hook portion of said holding device toward said disc member, and by effecting engagement of hook portion of said holding device with structure of the wheel, with said biasing means in a compressed state, so as to cause, upon release of insertion force, a clamping force to be exerted by said hook portion and said disc member upon portions of the wheel positioned therebetween, and thereby to secure said disc member in place proximate the mounted tire; and
applying a spray of tire dressing material to the sidewall of a tire mounted on the wheel.

16. The method of claim 15 including the additional step of removing at least one area of said disc component defined by said openings-defining structure so as to form at least one actual opening through said disc component.
